(19) United States
(12) Patent Application Publication
(10) Pub. No.: US 2008/0179199 A1
(43) Pub. Date: Jul. 31, 2008

(54) Economical and Reliable Gas Sensor

(76) Inventors: Philippe A. Coignet, Bear, DE (US); Samuel E. Moore, Middletown, DE (US)

Correspondence Address: AIR LIQUIDE;Intellectual Property, 2700 POST OAK BOULEVARD, SUITE 1800, HOUSTON, TX, 77056, US

(21) Appl. No.: 11/768,024

(22) Filed: Jun. 25, 2007

Related U.S. Application Data
(60) Provisional application No. 60/870,756, filed on Dec. 19, 2006.

(51) Int. Cl. G01F 1/64

(52) U.S. Cl. 205/793; 204/424

(57) ABSTRACT

A gas sensor system includes a membrane electrode assembly including a polymer electrolyte membrane and electrode layers disposed on opposing sides of the membrane, where an anode side of the sensor is defined at first side of the assembly and a cathode side of the sensor is defined at a second side of the assembly . The gas sensor is configured to detect a gas in an environment (e.g., a housing, a pipe, an open environment, etc.) by measuring an open circuit voltage between the anode and the cathode sides of the assembly. The gas sensor provides a rapid response that measures gas concentration in the environment and is further durable, reliable and relatively inexpensive to manufacture.

### CROSS-REFERENCE TO RELATED APPLICATIONS

This application claims priority from U.S. Provisional Patent Application Ser. No. 60/870,756, entitled “Design of a Low-Cost, Reliable and Durable Hydrogen Detector,” and filed Dec. 19, 2006, the disclosure of which is incorporated herein by reference in its entirety.

### BACKGROUND

1. Field

The disclosure herein pertains to gas sensors, such as hydrogen sensors.

2. Related Art

The use of hydrogen in different technologies and industries is growing. For example, the use of hydrogen fuel cells is becoming increasingly important due at least in part to the fact that such fuel cells provide a clean and substantially pollutant free energy source in comparison to traditional combustion energy sources.

The use of hydrogen in fuel cells and other technologies typically requires sensors or detection devices that monitor hydrogen (for safety purposes and/or for controlling hydrogen concentration) in an environment surrounding a system to which hydrogen is being provided. A number of different sensing technologies are known for measuring hydrogen concentration, including the use of electrochemical sensors, pellistors, solid state sensors, chemistors, cathetometers, sound acoustic wave sensors, optical sensors and nanotechnology based sensors.

As a result of the expected increase in fuel cell use and other commercial uses of hydrogen, it is desirable to provide a hydrogen detector or sensor that is reliable, safe and durable and that is also economical to produce.

### SUMMARY

Hydrogen sensor systems and corresponding methods are described herein that provide effective, economical and reliable detection of hydrogen and/or other gases within an enclosure.

In an exemplary embodiment, a gas sensor system comprises an enclosure, and a gas sensor connected with the enclosure and comprising a membrane electrode assembly. The membrane electrode assembly comprises a plurality of layers including a polymer electrolyte membrane and electrode layers disposed on opposing sides of the membrane, where an anode side of the gas sensor is defined at a first side of the membrane electrode assembly and a cathode side of the gas sensor is defined at a second side of the membrane electrode assembly. The gas sensor further comprises a channel that facilitates fluid communication between the anode side of the assembly and gas present within the enclosure, and the gas sensor is configured to measure a concentration of a gas within the enclosure by measuring an open circuit voltage between the anode side and the cathode side of the assembly.

In another exemplary embodiment, a gas sensor system comprises a gas sensor including a membrane electrode assembly and a housing that at least partially encloses the membrane electrode assembly. The gas sensor is configured to detect a gas by measuring an open circuit voltage between an anode side and a cathode side of the membrane electrode assembly. In addition, the gas sensor comprises pipe sections that connect with and extend transversely from the housing. The pipe sections connect with a channel disposed on at least one of the anode side and the cathode side of the membrane to facilitate fluid communication between a gas flowing within the pipe sections and the anode or cathode side of the membrane.

The above and still further objects, features and advantages of the systems and methods described herein will become apparent upon consideration of the following detailed description of specific embodiments thereof, particularly when taken in conjunction with the accompanying drawings, wherein like reference numerals designate like components.

### BRIEF DESCRIPTION OF THE DRAWINGS

FIG. 1 schematically depicts a gas detection system that detects hydrogen and/or other gaseous concentrations in an enclosure.

FIG. 2A depicts an exploded view of an exemplary embodiment of a gas sensor for use in a detection system as schematically shown in FIG. 1.

FIG. 2B depicts a view in perspective of the gas sensor of FIG. 2A.

FIG. 3 depicts a view in perspective of an exemplary embodiment of a gas detection system in which the sensor of FIGS. 2A and 2B is connected with a ventilated enclosure to facilitate measurement of hydrogen and/or other gas concentrations within the enclosure.

FIG. 4 is a plot of the measured output voltage data of a sensor in a gas detection system of a similar type as depicted in FIG. 3, where the gas content within the enclosure was monitored by the sensor while air was flowing into and through the enclosure at about 900 ml/min. (volume of enclosure about 390 ml), with air flows being provided having concentrations of 1% hydrogen by volume and 2% hydrogen by volume.

FIGS. 5A and 5B depict views in perspective of other exemplary embodiments of a gas sensor for use in a gas detection system to facilitate measurement of hydrogen and/or other gas concentrations in an environment surrounding the sensor.

FIGS. 6A to 6H depict schematic views of exemplary embodiments of gas detection systems including sensors having configurations similar to those depicted in Figures FIGS. 2 and 5.

FIG. 7 is a plot of the measured output voltage data of sensors disposed in a gas detection system as set forth in FIG. 6G, where gas content was monitored by the sensor while air was flowing through a conduit to which the anode side of the sensor was connected at a flow rate of about 900 ml/min. and with a content of 2% hydrogen by volume.

### DETAILED DESCRIPTION

The systems and methods described herein include the use of a gas sensor comprising a membrane electrode assembly (MEA) that is operated at open circuit voltage or OCV (i.e., there is no external voltage or load connected to operate the sensor). As described below, a voltage meter or voltmeter can be connected between two open terminals that connect with the electrodes of the sensor to measure the OCV, where the measured OCV value is used to detect gas concentrations in an environment surrounding the sensor.

As described in further detail below, the sensor can be connected with an enclosure (e.g., a housing for a battery, a fuel cell or any other type of equipment) to monitor the concentration of hydrogen and/or other gases within the enclosure. Alternatively, the sensor can be configured to monitor the presence and concentration of hydrogen and/or any other gases in a pipeline or in an environment or atmosphere in which the sensor is disposed (e.g., monitoring gas concentrations within a room or in an open environment outside and proximate a building and/or equipment in which a known gas is being delivered or used).

The membrane electrode assembly of the sensor can be easily constructed using a suitable polymer electrolyte membrane with electrode material and/or other layers disposed on opposing sides of the membrane (e.g., in a three or five layer construction). The electrode material layers are formed from one or more suitable metals (e.g., platinum or palladium) in a mixture with other suitable materials (e.g., carbon, ionomers, PTFA, etc.). The MEA can be suitably connected to a housing or enclosure so as to detect and monitor hydrogen and/or other gas concentrations within the enclosure. Alternatively, the MEA can be mounted in any suitable location to detect and monitor the presence of hydrogen and/or other gases in an environment surrounding and proximate the sensor.

In embodiments in which the gas sensor is connected with an enclosure, the gas sensor is configured such that one side of the MEA including one electrode material layer (the anode) of the sensor is exposed to and in contact with the gas being monitored within the enclosure while the other side of the MEA with the other electrode material layer (the cathode) of the sensor is exposed to and in contact with a reference gas (e.g., air or nitrogen). Similarly, when monitoring a gaseous content in an open atmosphere or environment surrounding and proximate the sensor, the anode side of the MEA is exposed to an atmosphere in which a measuring gas is present, while the cathode side of the MEA is exposed to an atmosphere in which a reference gas is present. In addition, it is noted that the gas sensor can be designed such that a solid reference rather than a reference gas is utilized for obtaining a reference potential.

The MEA gas sensor can be provided in any suitable geometric configuration, such as a planar types or hollow fiber types. In addition, the gas sensor can include a single MEA or a plurality of stacked MEAs, depending upon the requirements of a particular application.

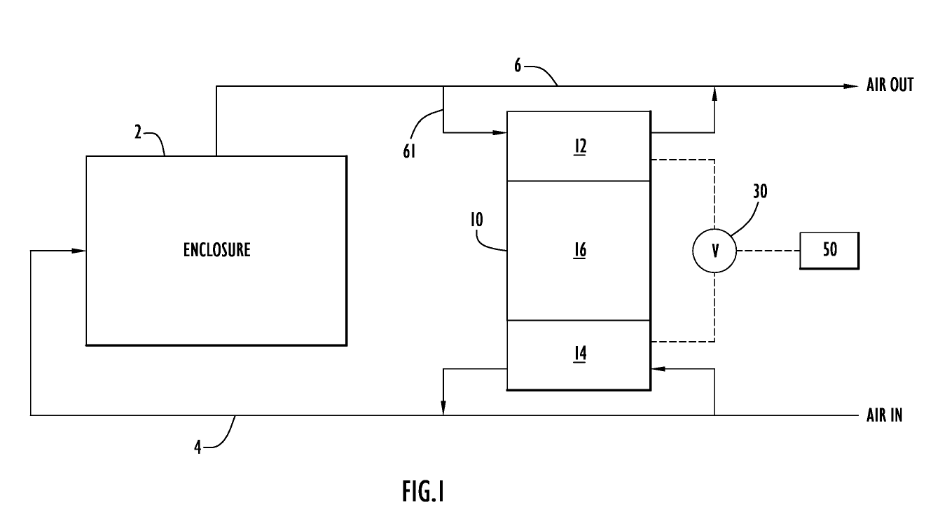

A schematic diagram of a gas detection system is depicted in FIG. 1. The system includes a ventilated enclosure in which gases such as hydrogen gas may be present (e.g., due to a leak of hydrogen from piping and/or equipment within the enclosure). The enclosure can be configured, for example, as a housing for a battery, a fuel cell system, or any other equipment typically provided within an enclosure. While the gas detection system is described in relation to the detection of hydrogen concentration within an enclosure, it is noted that the invention is not limited to hydrogen detection. Rather, the present invention can be used to detect concentrations of one or more different gaseous species using a membrane electrode assembly with a suitable polymer electrolyte membrane and catalysts as described below.

Referring to FIG. 1, the enclosure 2 includes an air inlet line 4 to direct an inlet flow of air into the enclosure and an air outlet line 6 to direct the air flow out of the enclosure. The air flow lines 4 and 6 can be used for providing continuous or intermittent ventilation within the enclosure. Ventilation within the enclosure can be provided, e.g., by a fan or blower that directs ambient air from the surrounding environment into and through the enclosure via the air inlet and outlet lines. In embodiments in which the device housed within the enclosure comprises a fuel cell, the enclosure can further be configured to receive one or more hydrogen fuel inlet streams as well as other optional inlet streams (e.g., a pure oxygen stream) and/or outlet streams from the fuel cell (e.g., an outlet stream directing reaction products such as water from the fuel cell).

A gas sensor 10 is connected in-line with the inlet and outlet air flow lines as shown in FIG. 1 so as to monitor gas flowing through the enclosure 2. The sensor 10 includes a membrane electrode assembly (MEA) comprising a polymer electrolyte membrane, which can comprise a three-layer or five-layer structure as is known in the art. Preferably, the MEA comprises a five-layer structure that includes a suitable polymer electrolyte material 16 disposed between layers forming an anode side 12 and layers forming a cathode side 14 of the MEA. In particular, each of the anode side 12 and cathode side 14 of the MEA comprise dual layers of an electrode layer adjacent the membrane and a gas diffusion layer disposed adjacent the electrode layer. The anode side is exposed to and in fluid communication with the measured gas in which detection and concentration of hydrogen is to be determined, while the cathode side is exposed and in fluid communication with a reference gas (or solid reference material).

The polymer electrolyte membrane of the MEA can be constructed of any suitable organic and/or inorganic materials that facilitate conduction of protons formed at the anode side of the sensor (due to the breakdown of hydrogen from the measured gas into protons and electrons) through the membrane to the cathode side of the membrane while preventing the flow of any gases across the membrane. Exemplary polymer materials that are suitable for forming the polymer electrolyte membrane material of the hydrogen sensor include sulfonated perfluoropolymers (e.g., fluoroethylene), such as sulfonated tetrafluorethylene copolymers commercially available under the trademark NAFION (DuPont), where the NAFION based polymer is blended with one or more other suitable polymers that provide mechanical reinforcement for the membrane. An exemplary NAFION based material that is suitable as a material of construction for the polymer electrolyte membrane includes a blend of a NAFION based material with another polymer that provides mechanical re-enforcement and which is commercially available under the trademark NAFION XL. Another exemplary polymer material that is a suitable material of construction (e.g., in combination with other polymers) for the polymer electrolyte membrane is a perfluorinated polymer commercially available under the trademark GORE-SELECT (W.L. Gore & Associates). However, it is noted that any suitable proton exchange membrane fuel cell MEA can be utilized in any of the sensors described herein.

As noted above, the anode and cathode sides are preferably formed as dual layers on opposing sides of the polymer electrolyte membrane to form a five-layer MEA structure. The dual layers formed on either side of the membrane include an electrode layer disposed adjacent one side of the membrane and a gas diffusion layer disposed adjacent the electrode layer and defining an outer side of the MEA structure. The electrode layer can be formed on one side of the membrane as a blend or mixture of a suitable precious metal catalyst material (e.g., platinum) supported by carbon in a suitable ionomer that facilitates conduction of protons through the electrode layer. The gas diffusion layer, which is provided adjacent the electrode layer to form the dual layer for each of the anode and cathode sides of the MEA, can be formed of any suitable electronic materail (e.g., a carbon based material) that facilitates gas diffusion through the layer and conduction of electrons.

An electrically conductive contact is provided on each of the anode and cathode sides of the MEA in electrical contact (via the gas diffusion layer) with the anode and cathode. Terminals (which are shown as dashed lines in FIG. 1) are connected with contacts and lead to a voltmeter 30. A measurement of OCV between the anode and cathode sides of the MEA is obtained using the voltmeter, and this OCV measurement is correlated with the presence and concentration of hydrogen (and/or other gases) within the enclosure 2 during operation of the sensor. The voltmeter 30 can be monitored manually or, alternatively, connected to a suitable controller (such as a controller 50 shown in FIG. 1) to provide the OCV measurement to the controller.

In a system such as the type schematically depicted in FIG. 1, a positive OCV measured by the sensor indicates the presence of hydrogen in the enclosure, such as a hydrogen leak from equipment and/or piping disposed within the enclosure. The OCV value is correlated with a hydrogen concentration in the enclosure and can be used to control the system (e.g., signaling a warning or a system shutdown).

In the system of FIG. 1, sensor 10 is connected with a side stream 61 of the air outlet line 6 so as to permit a portion of the exiting air from the enclosure 2 to flow toward and be in contact with one side of the polymer electrolyte membrane 16 including anode 12. The sensor 10 can include any suitable gas channel that permits a portion of exiting air from the enclosure to flow and be in fluid communication with the anode side 12 of the MEA. The exiting air contacting the anode side 12 of the MEA is the measured gas in which the presence and concentration of hydrogen is being detected. In addition, sensor 10 is connected with a side stream 41 of the air inlet line 4 so as to permit a portion of the inlet air entering the enclosure to pass through a suitable gas channel and be in fluid communication with the cathode side 14 of the MEA, thus serving as the reference gas for the sensor. Alternatively, it is noted that each of the anode and cathode sides of the MEA can be connected directly and in-line with the air inlet and outlet lines.

In the embodiment depicted in FIG. 1, a continuous flow of air is provided to ventilate the enclosure. However, in other embodiments described below, air flow can be provided continuously or intermittently. Also, the flow rate of air through the enclosure can be modified based upon the measured hydrogen concentration. For example, if the sensor measures an OCV value representative of the hydrogen concentration within the enclosure that is above a threshold value (e.g., above 1% by volume), the flow rate of ventilation air through the enclosure can be increased to a suitable level in order to reduce the concentration of hydrogen to acceptable levels within the enclosure. For example, the controller 50 shown in FIG. 1 can be configured to automatically adjust and control the flow rate of air through the enclosure based upon measured OCV values by the sensor 10.

In an alternative embodiment, the system can be configured such that the gas channel at the anode side of the sensor is in direct communication with the enclosure rather than with the air outlet line. In addition, the cathode side of the sensor in the system of FIG. 1 can be exposed directly to ambient air surrounding the enclosure rather than a portion of the inlet air or gas stream entering the enclosure. In this embodiment, the ambient air serves as a suitable reference gas for the sensor. Further still, the cathode or reference side can be further modified to include a solid reference or any other type of reference rather than using a reference gas. The selection of a specific sensor embodiment of the invention, in which the anode side and/or cathode side of the MEA of the sensor connect with piping in which a measured or reference gas flows or are directly exposed to the internal volume within an enclosure or to an ambient environment surrounding the sensor will depend upon a particular application.

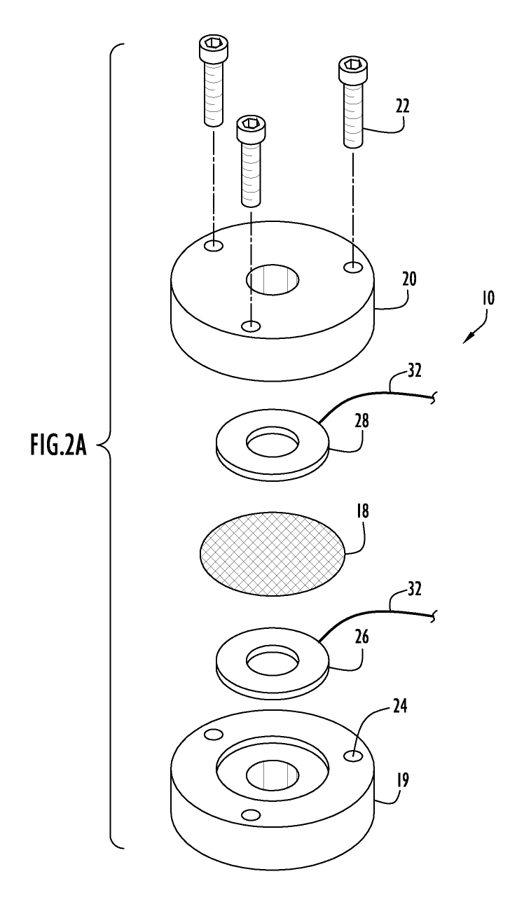

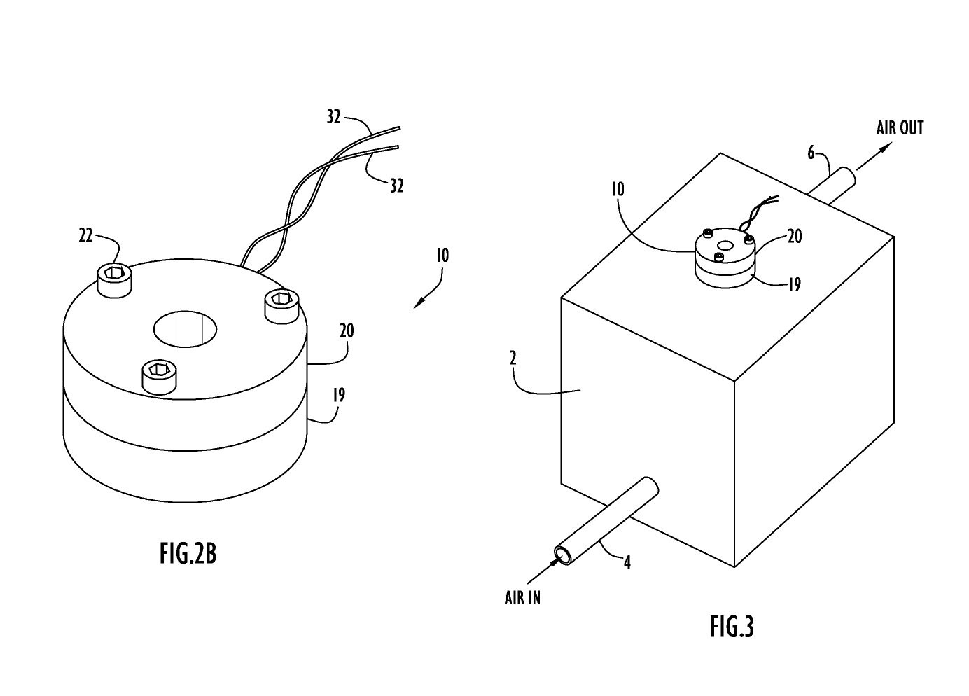

An exemplary embodiment of a planar, stacked layer MEA configuration for the hydrogen sensor is depicted in FIGS. 2A and 2B. The sensor 10 is generally cylindrical in configuration, including first and second annular or ring-shaped housing members 19, 20 that are formed of a suitable non-conductive plastic or polymer material (e.g., nylon) and that connect together to substantially enclose and contain a five-layer membrane electrode assembly 18 having a five layer structure as noted above (i.e., gas diffusion layer/electrode/polymer electrolyte membrane/electrode/gas diffusion layer). The polymer electrolyte membrane, electrode layers and gas diffusion layers of the MEA 18 are formed from suitable materials such as those noted above.

An opening at a central location on each annular housing member 19, 20 serves as a gas channel that permits exposure of the anode side or cathode side of the MEA to the measured or reference gas. A metal contact 26, 28 is also disposed on each side of MEA 18, where each metal contact is composed of a suitably electrically conductive material (e.g., stainless steel) and is also annular in geometric configuration. A central opening of each metal contact is aligned within the respective housing member 18, 20 such that the gas channel on each side of the MEA 18 is generally linear from an outer surface of the sensor to the MEA. Each of the first and second housing members 18, 20 can further include a slight indentation on its inner surface (i.e., the surface of the housing member that faces the opposing housing member) so as to receive and retain the corresponding metal contact 26, 28 in an appropriate alignment within the housing during sensor assembly.

One or more suitable fasteners are provided to effectively secure the first housing member 19 to the second housing member 20. In the embodiment of FIGS. 2A and 2B, a series of threaded fasteners 22 are inserted through openings extending through and located at uniformly spaced and peripheral locations along the second housing 20 member. The threaded fasteners 22 extend into corresponding threaded bores 24 disposed at uniformly spaced and peripheral locations along first housing member 19. The first and second housing members are mated and secured together in a gas tight relationship by engagement of the threaded fasteners 22 with the threaded bores 24. Alternatively, it is noted that the first and second housing members can be secured together in a gas tight relationship with each other in any other suitable manner during assembly of the sensor (e.g., via adhesive bonding of the two housing members together).

The five-layer MEA 18 is suitably dimensioned to fit between the first and second housing members and contact a sufficient portion of the facing surface (e.g., the entire facing surface, a significant or major portion of the facing surface, or some portion of the facing surface) of each metal contact 26, 28 upon securing of the two housing members to each other in the manner noted above. In addition, terminals in the form of conductive wiring 32 are secured within the sensor in electrical contact with the contacts 26 and 28, and each terminal extends transversely from the sensor and has a sufficient length to connect the terminal with a voltmeter. The voltmeter can be of any conventional or other suitable type capable of measuring the open circuit voltage (OCV) between the anode and cathode sides of the MEA during operation of the sensor.

The membrane electrode assembly design of the sensor described above is relatively inexpensive and very simple to manufacture. For example, since many different types of commercially available MEAs can be used to manufacture the sensor, the sensor can typically be manufactured at a fraction of the cost in comparison to other commercially available hydrogen detection systems. Further, since the sensor operates at OCV, it is not subjected to high voltage loads and is subjected to little or no proton flow through the membrane. The sensor is therefore very reliable, is very durable and has an extended lifetime in comparison to conventional MEAs in fuel cells used for energy generation. In addition, and as described in further detail below, the sensor has a very short response time in providing an accurate and reliable detection and measurement of hydrogen and/or other gas concentrations.

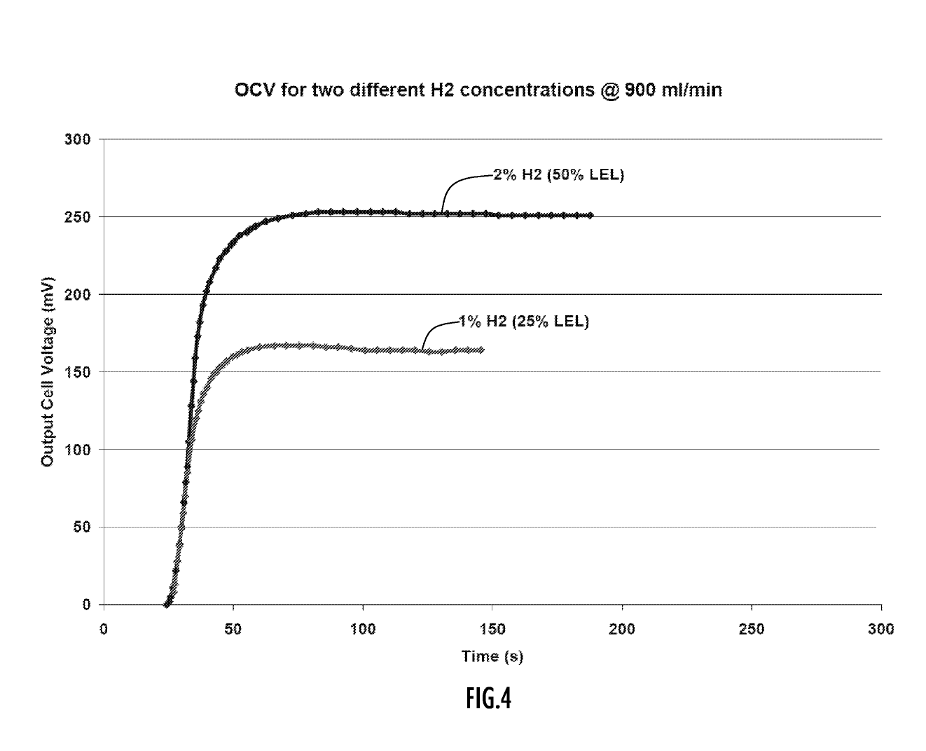

As previously noted, the sensor of FIGS. 2A and 2B can be connected to a housing or enclosure, such as the enclosure described above and depicted in FIG. 1, to facilitate detection and monitoring of the concentration of hydrogen and/or other gases within the enclosure. In an exemplary embodiment depicted in FIG. 3, the sensor of FIGS. 2A and 2B is connected directly to an enclosure 2 to form a hydrogen detection system, where the enclosure includes inlet and outlet air flow lines 4, 6 that provide ventilation for the enclosure. For example, the enclosure could be a housing or compartment for a fuel cell, a battery or any other device, where the concentration of hydrogen is detected within the housing to determine whether a leak is occurring within the fuel cell during operation.

Referring to FIG. 3, a sensor 10 is connected directly to enclosure 2, where the anode side of the MEA of the sensor is in fluid communication with the interior of the enclosure to facilitate exposure to gases within the enclosure. The sensor can be connected in any suitable manner to the enclosure (e.g., via threaded attachment, adhesive bonding, etc.).

While it is noted that either side of the sensor of FIGS. 2A and 2B could be used to monitor the measured gas or the reference gas, for ease of reference the sensor 10 is referred to in this and further embodiments with the housing member 19 including the anode side of the MEA 18 (for exposure to the measured gas) and the housing member 20 including the cathode side of the MEA 18 (for exposure to the reference gas or solid reference material). Thus, the sensor 10 is connected to the enclosure 2 such that the end of housing member 19 including the gas channel is in fluid communication with the interior of the enclosure, while housing member 20 of the sensor is exposed to the ambient environment surrounding the housing.

The detection system of FIG. 3 is capable of detecting hydrogen concentrations by monitoring the OCV measured by the voltmeter which is electrically connected to the anode and cathode sides of the MEA. A positive, non-zero OCV value indicates the presence of hydrogen. The OCV value can further be correlated with a concentration of hydrogen. The system can be used to detect the presence of a hydrogen leak from piping and/or equipment disposed within the enclosure. The system can further determine a concentration of hydrogen within the enclosure and whether such concentration is approaching a hazardous level (e.g., approaching the lower explosive level). The equipment can then be shut down or controlled accordingly and/or suitable ventilation provided within the enclosure to effectively reduce the hydrogen concentration level within the enclosure.

The system can utilize the measured OCV values of the sensor to control operation of the system (e.g., to control operation of a fuel cell system within the enclosure or housing) based upon one or more OCV threshold values. For example, in a hydrogen leak detector system (e.g., for detecting leaks in piping or equipment within the enclosure), a measurement by the sensor of a first OCV threshold value (e.g., about 50 mV) may provide an indication that maintenance of the system is required. A second measured OCV threshold value (e.g., about 180 mV or greater) may provide an indication that the hydrogen concentration is too high (e.g., at a lower explosive limit of 1% or greater) and that the system must be shutdown.

In addition, ventilation of the enclosure via lines 4 and 6 can be controlled (e.g., automatically via a controller) based upon the OCV measurements. For example, air flow can be intermittent within the enclosure, where there is no air flow or ventilation within the enclosure during “normal” system operation (i.e., at OCV measurements below a threshold value). Upon achieving or exceeding a predetermined OCV value (i.e., the threshold value), ventilation of the enclosure can be initiated by flowing air through the enclosure, with the ventilation being controlled until the OCV value falls within an acceptable range.

Alternatively, continuous ventilation can be provided within the enclosure, with the flow rate of air through the enclosure being selectively controlled based upon measured OCV value. For example, if a measured OCV value rises above a threshold value, the flow rate of air through the enclosure can be increased until the OCV value decreases to a value that falls with predetermined “normal” operating limits for the system.

The correlation of measured OCV value with a particular gas concentration within an enclosure or within an open environment surrounding the sensor will depend upon the gas being measured, a particular system and/or particular sensor design, such that it may be desirable to calibrate the sensor with a specific system using a known gas concentration prior to implementing the sensor for detection during system operation. Since the sensor operates at OCV, the sensor will typically generate a voltage of no greater than about 1.2 V. Further, in situations in which the sensor generates very low voltages, the system can be designed to connect a number of MEAs together in series to increase the measured OCV value and obtain a suitable signal-to-noise ratio, where the measured OCV value is greater than any signal noise that exists in the electrical circuit of the sensor.

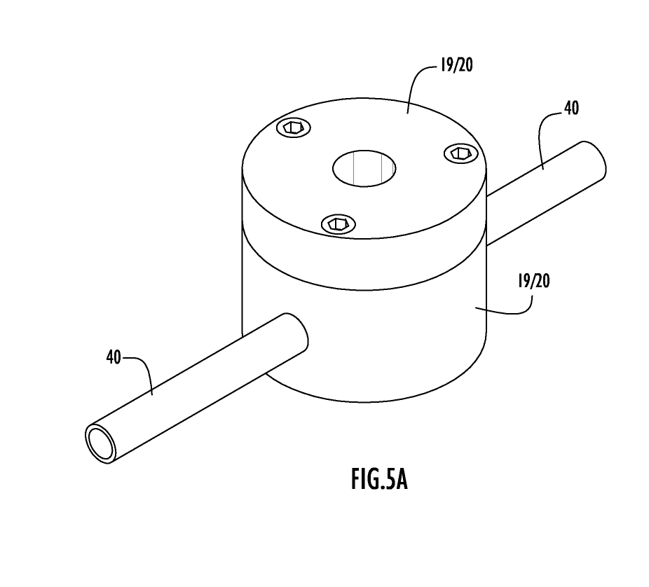

A system configuration similar to the design described above and depicted FIG. 3 was tested by continuously flowing air at a flow rate of about 900 milliliters per minute (ml/min.) through an enclosure having a volume of 390 ml. The tests were conducted using known concentrations of hydrogen in the air at levels of about 1% by volume (25% of the lower explosive limit for hydrogen) and about 2% by volume (50% of the lower explosive limit for hydrogen). The sensor terminals were connected with a voltmeter to measure the OCV of the sensor during system operation using the air flows with the two known hydrogen concentrations. The response of the sensor can be seen in the voltage data plotted in FIG. 4.

As can be seen from the data plotted in FIG. 4, the gas sensor measures a voltage that initially rises and then achieves a relatively constant value for each of the two air flows through the system. For each test, the sensor achieved a steady state or relatively constant OCV reading within a relatively short time period (less than about 60 seconds), with the OCV measured value corresponding with 1% hydrogen concentration being about 160 mV and the OCV measured value corresponding with 2% hydrogen concentration being about 250 mV.

The data of FIG. 4 shows the effectiveness of the sensor for detecting hydrogen concentrations at a relatively short time periods after system start-up. The time period required to achieve steady state for OCV readings of the sensor will vary depending upon different system configurations (e.g., based upon the volume of gas that is being monitored and the time required to establish a generally uniform mixture of the gas through the volume being monitored by the sensor), and thus can be even more rapid for different systems (e.g., for monitoring gas concentrations of gas flowing within a conduit as described below).

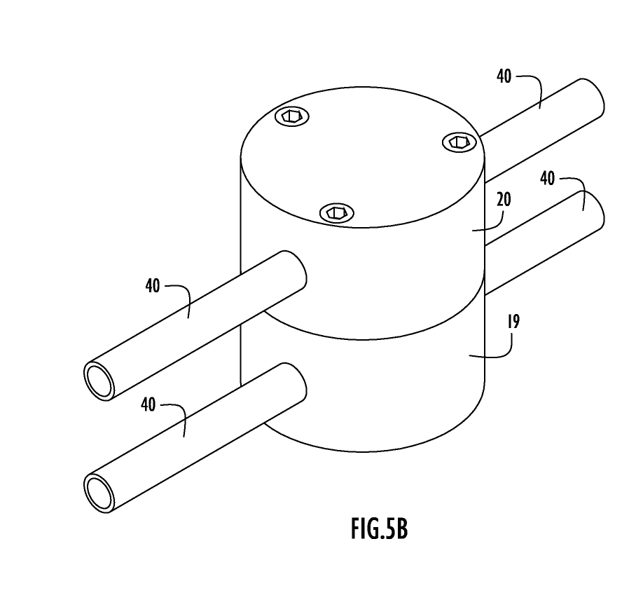

The sensor of FIGS. 2A and 2B can be modified in a number of different ways and utilized in a number of different system configurations. In certain embodiments of a gas detection system, the sensor can be modified as shown in FIGS. 5A and 5B. As shown in FIG. 5A, a gas channel includes an elongated tube or piping structure that facilitates gas flow into a housing member 19/20 of the sensor to ensure flow and contact of the reference and/or measured gas with the corresponding anode side or cathode side of the sensor. The gas channel is provided in housing member 19/20 via tubular or pipe sections 40 that extend transversely and at opposing locations with respect to each other from side wall locations of the housing member. The pipe sections 40 terminate at or within a cavity of the housing member 19/20 that includes the respective anode side or cathode side of MEA 18, thus permitting a measured gas or reference gas to flow within the sensor housing and to be in fluid communication with the anode side or cathode side of the MEA during system operation. The housing member 19/20 further differs from the corresponding housing member of the sensor of FIGS. 2A and 2B in that this housing member does not include a central opening that extends to an external or exposed end of the housing member, since the gas channel is provided by the transversely extending pipe sections.

The embodiment of FIGS. 2A and 2B can be modified to obtain the embodiment of FIG. 5 by providing openings at sidewall locations along housing member 19/20 to facilitate connection with pipe sections 40, and further securing a housing cap to the exposed end or surface of housing member 18 so as to seal the central opening of the housing member 18 at this exposed surface. Alternatively, the housing member 19/20 can be constructed so as to have a central opening that extends from the inner surface into the housing member but terminates within the housing member (i.e., the opening does not extend to the opposing, exposed end of the housing member). The other housing member which does not include the transversely extending pipe sections is annular shaped and includes a central opening that extends to the exposed end of the housing member so as to define a gas channel providing fluid communication with the corresponding anode side or cathode side of the MEA.

The embodiment of FIG. 5B is similar to FIG. 5A, with the exception that both housing members 19, 20 include pipe sections 40 that extend transversely from the housing members and terminate within cavities within the housing members so as to provide separate gas channels to both the anode and cathode sides of the MEA.

The embodiment of FIG. 5B can be implemented for use, for example, in the embodiment of FIG. 1, such that air inlet line 4 is in fluid communication with pipe sections 40 of housing member 20 and air outlet line 6 is in fluid communication with pipe sections 40 of housing member 19.

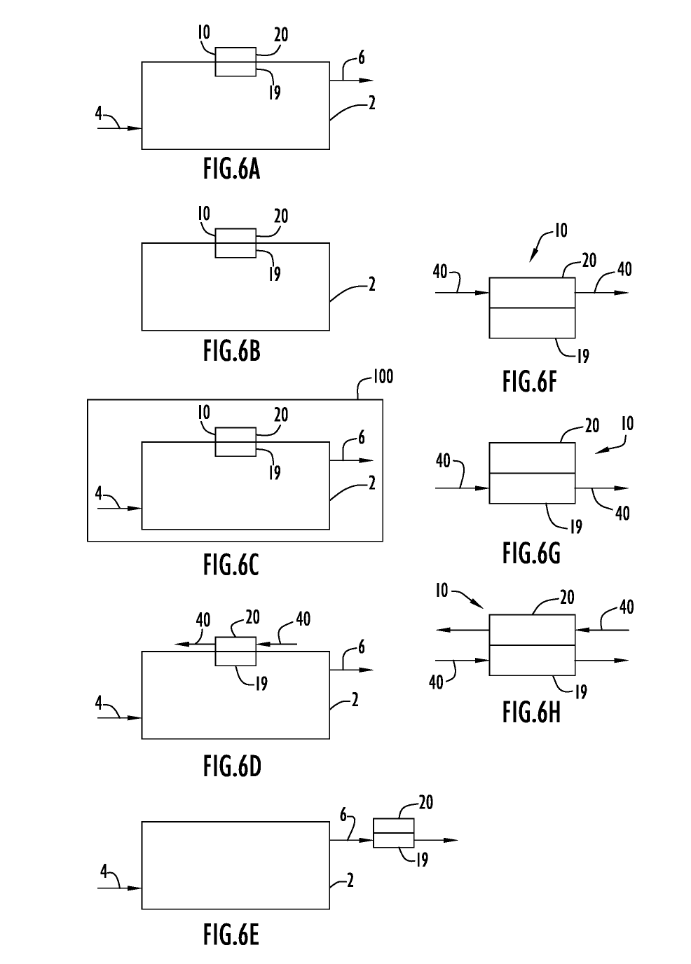

A number of different gas detection systems can be implemented utilizing the gas sensors described above and depicted in FIGS. 2 and 5 including, without limitation, the gas detection systems schematically depicted in FIGS. 6A to 6H. The schematic view depicted in FIG. 6A corresponds with the system of FIG. 3, in which a sensor as shown in FIG. 2 is connected such that the housing member 19 is partially disposed within enclosure 2 to directly expose and establish fluid communication between the anode side of the MEA with the interior of the enclosure in which the measured gas is located. The cathode side within housing member 20 of the sensor is exposed to the ambient environment surrounding the enclosure which provides air as the reference gas. Alternatively, the cathode side can be closed to the ambient environment and include a solid reference material. This sensor system can be used for a variety of different applications in which the detection and concentration of hydrogen or other gases is to be monitored within a closed space or enclosure (e.g., a room, housing, box, etc.), where the enclosure may or may not be ventilated.

The embodiment depicted in FIG. 6B is similar to that shown in FIG. 6A, with the exception that there is no ventilation of the enclosure 2 (i.e., no inlet and outlet airflow lines). In the embodiment of FIG. 6C, the system of FIG. 6A is provided within a second enclosure 100, which may or may not be ventilated. In this embodiment, the cathode side of the MEA is exposed to the ambient air environment within enclosure 100.

In the embodiment of FIG. 6D, the sensor has a configuration as shown in FIG. 5A. The anode side of the MEA within housing member 19 is exposed directly to the measured gas within the interior of the enclosure. The housing member 20 including the cathode side of the MEA includes piping sections 40, where the piping sections 40 direct a reference gas through housing member 20. The reference gas supplied in piping sections can be, for example, compressed air or nitrogen. Alternatively, the piping sections can be connected with air inlet 4 that delivers ventilation air into the enclosure 2.

The embodiment of FIG. 6E also utilizes a sensor as depicted in FIG. 5A. However, in this embodiment, housing member 19 including the anode side of the MEA includes transversely extending pipe sections connected with the outlet air line 6 for enclosure 2. The housing member 20 including the cathode side of the MEA can be exposed to the ambient air surrounding the system or, alternatively, includes a closed solid reference material.

In the embodiment of FIG. 6F, the detection system includes the sensor of FIG. 5A, with the transverse pipe sections 40 being connected and in fluid communication with the cathode side of the MEA disposed in housing member 20, while the anode side of the MEA within housing member 19 is exposed to the ambient air in which the sensor is placed. The reference gas flowing within pipe sections can be, for example, a supply of nitrogen or oxygen. This embodiment is useful, for example, for detecting leaks and monitoring concentrations of hydrogen or other gases in large open environments such as large open spaces or outside environments, where the sensor functions as a pneumatic sensing device that measures air born concentrations of hydrogen and/or other gases. For example, a sensor of this type can be placed at a suitable location proximate piping or equipment in which hydrogen or other gases are delivered and/or processed. This sensor can further be used, for example, as a “sniffer” sensor to detect concentrations of hydrogen or other gases near pipe fittings in conduit lines.

The embodiment of FIG. 6G is the opposite of that depicted in FIG. 6D, where the transverse pipe sections 40 are connected and in fluid communication with the anode side of the MEA within housing member 19. The cathode side of the MEA within housing member 20 can be exposed to the ambient air surrounding sensor or, alternatively, be exposed to a solid reference material. The sensor of this embodiment is useful, e.g., for placing in-line in a conduit or piping structure so as to detect and monitor hydrogen and/or other gas concentrations present in a gas stream flowing within the conduit.

In the embodiment of FIG. 6H, both housing members 19, 20 include transverse pipe sections 40 as shown in FIG. 5B. As noted above, this embodiment can be used for the system configuration of FIG. 1 (i.e., where the air inlet and outlet lines flow through housing member 20 and housing member 19, respectively). The flow of the measured and reference gases through the sensor can be in the same or opposing directions.

As noted above, the sensors described above can be used in a number of different embodiments. For example, as noted above, one or more of the sensor types set forth in FIGS. 6A-6H can be used as “sniffer” sensors to detect hydrogen or other gas concentrations around pipe fittings (e.g., detecting leaks in fitting connections). One or more of these other types of sensors can also be used, e.g., in a housing or cabinet for hydrogen or other gas cylinders. The sensors can further be used for any other types of applications in which the detection and concentration of hydrogen or other gases is desired.

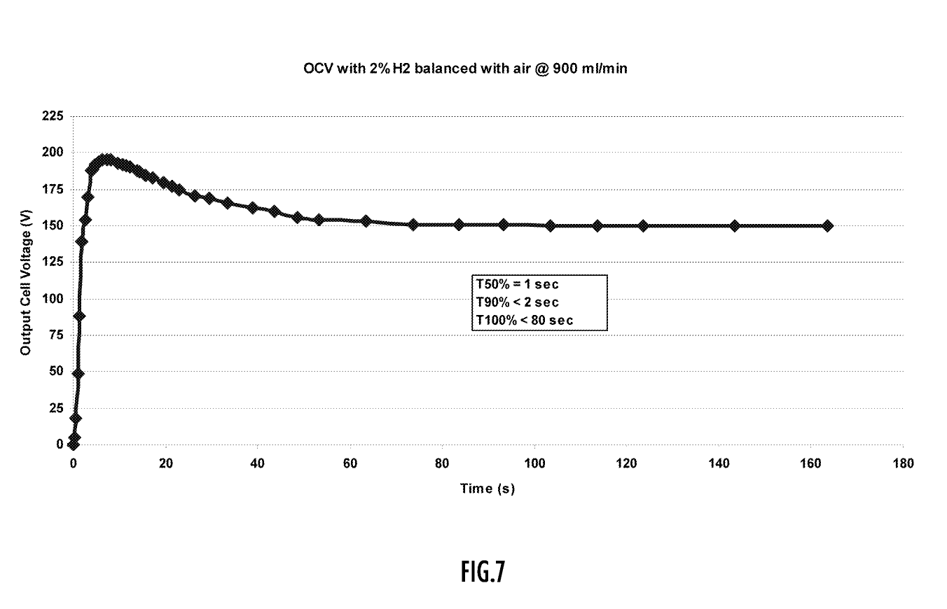

A system configuration similar to that schematically shown in FIG. 6G (using a sensor as shown in FIG. 5A) was tested by continuously flowing air at a flow rate of about 900 ml/min. through a conduit to which the sensor was connected such that the anode side of the MEA was in fluid communication with the interior of the conduit and the cathode side of the MEA was exposed to the ambient air outside the conduit. The concentration of hydrogen in the air flowing within the conduit was about 2% by volume, and the OCV was measured between the anode and cathode sides of the MEA using a voltmeter. The measured OCV data for this system configuration is plotted in FIG. 7.

It can be seen from the data of FIG. 7 that the system of FIG. 6G has a rapid response time, where 50% of the steady state response (t_{50%}) is achieved in about 1 second and 90% of the steady state response (t_{90%}) is achieved in less than 2 seconds. The steady state response (t_{100%}) is achieved in less than 80 seconds. The very rapid response time of this sensor configuration shows that this sensor is very effective for use for safety applications in which rapid detection of a hydrogen leak and hydrogen concentration in an environment is necessary to ensure an appropriate response measures are taken (e.g., safety alerts, system maintenance and/or system shut-down).

Referring again to the data plotted in FIG. 4, in which the system of FIG. 6A (also depicted in FIG. 3) was tested under the same airflow conditions, it can be seen that the time required for achieving 90% of the steady state response for the sensor is much faster using the system of FIG. 6G. This is due in part to the smaller volume of measured gas being exposed to the anode side of the MEA for the sensor configuration of FIG. 6G in relation to the sensor configuration of FIG. 6A (and FIG. 3).

The MEA sensor designs and system configurations described above are very simple to manufacture and can be provided at a fraction of the cost of many conventional hydrogen detection systems. As noted above, since the sensor operates at OCV and is not subjected to high voltages, with little or no proton flow through the membrane, the detection systems described above are very durable and provide reliable detection of gases such as hydrogen for extended periods of time. In addition, as noted above, the rapid response time of the sensor (e.g., response times of t_{50%}≦1 second and t_{90%}≦2 seconds for certain applications) renders the sensor ideal for safety applications, particularly applications in which rapid detection of hydrogen and/or other gases is essential to provide warning indications and provide control of system equipment.

Having described novel systems and methods for detection of hydrogen and/or other gases using an economic and reliable hydrogen sensor, it is believed that other modifications, variations and changes will be suggested to those skilled in the art in view of the teachings set forth herein. It is therefore to be understood that all such variations, modifications and changes are believed to fall within the scope as defined by the appended claims.

1. A gas sensor system comprising:
an enclosure; and
a gas sensor connected with the enclosure and comprising a membrane electrode assembly, the membrane electrode assembly comprising a plurality of layers including a polymer electrolyte membrane and electrode layers disposed on opposing sides of the membrane, wherein an anode side of the gas sensor is defined at a first side of the membrane electrode assembly and a cathode side of the gas sensor is defined at a second side of the membrane electrode assembly, the gas sensor further comprising a channel that facilitates fluid communication between the anode side of the assembly and gas present within the enclosure;
wherein the gas sensor is configured to determine a concentration of a gas within the enclosure by measuring an open circuit voltage between the anode side and the cathode side of the assembly.

2. The gas sensor system of claim 1, wherein the enclosure includes a gas inlet and a gas outlet to facilitate ventilation of the enclosure.

3. The gas sensor system of claim 2, wherein the channel is connected with the gas outlet to facilitate flow of gas exiting the enclosure into and through the channel.

4. The gas sensor of claim 3, wherein the gas sensor further comprises a second channel that facilitates fluid communication between the cathode side of the assembly and a reference gas.

5. The gas sensor of claim 4, wherein the second channel is connected with the gas inlet of the enclosure.

6. The gas sensor system of claim 2, wherein the gas sensor comprises a housing that at least partially encloses the membrane electrode assembly, and the channel comprises pipe sections that connect with and extend transversely from the housing and further connect with the gas outlet to facilitate flow of gas exiting the enclosure into a cavity within the housing that is in fluid communication with the anode side of the assembly.

7. The gas sensor system of claim 6, wherein the gas sensor further comprises a second channel comprising pipe sections that connect with and extend transversely from the housing and facilitate a flow of reference gas into a cavity within the housing that is in fluid communication with the cathode side of the assembly.

8. The gas sensor of claim 7, wherein the pipe sections of the second channel connect with the gas inlet of the enclosure.

9. The gas sensor system of claim 1, wherein the gas sensor further comprises a second channel that facilitates fluid communication between the cathode side of the assembly and an ambient environment surrounding the enclosure.

10. The gas sensor system of claim 1, wherein the gas sensor is configured to measure a concentration of hydrogen within the enclosure.

11. The gas sensor system of claim 1, wherein the polymer electrolyte membrane comprises a sulfonated perfluoropolymer.

12. The gas sensor system of claim 1, wherein the gas sensor further comprises a sensor housing including a first housing member that at least partially encloses the anode side of the membrane electrode assembly and a second housing member that at least partially encloses the cathode side of the assembly, and the first and second housing members are connected together to secure the assembly within the sensor housing.

13. The gas sensor system of claim 12, wherein at least one of the first and second housing members includes pipe sections that extend transversely from the housing member to facilitate a flow of gas through the pipe sections and into the sensor housing for exposure with the anode side or cathode side of the assembly.

14. The gas sensor system of claim 1, further comprising:
a controller configured to monitor the open circuit voltage measured by the sensor and control an operating parameter of equipment disposed within the enclosure based upon the measured open circuit voltage.

15. A method of measuring a concentration of a gas within an enclosure, comprising:
facilitating communication between a flow of gas present in the enclosure and a gas sensor, the gas sensor comprising a membrane electrode assembly formed from a plurality of layers including a polymer electrolyte membrane and electrode layers disposed on opposing sides of the membrane, wherein an anode side of the sensor is defined at a first side of the membrane electrode assembly and a cathode side of the sensor is defined at a second side of the membrane electrode assembly, and the gas sensor further comprises a channel that facilitates fluid communication between the anode side of the assembly and gas present within the enclosure;
measuring an open circuit voltage between the anode side and the cathode side of the gas sensor; and
determining a concentration of the gas within the enclosure based upon the measured open circuit voltage.

16. The method of claim 15, further comprising:
ventilating the enclosure by flowing a gas into the enclosure via a gas inlet and facilitating the exit of gas out of the enclosure via a gas outlet.

17. The method of claim 16, wherein the channel of the gas sensor is connected with the gas outlet, such that the open circuit voltage that is measured is based upon a flow of gas exiting the enclosure from the gas outlet and flowing into the channel.

18. The method of claim 16, wherein the gas sensor further comprises a second channel that facilitates fluid communication between the cathode side of the assembly and a reference gas.

19. The method of claim 18, wherein the second channel is connected with the gas inlet of the enclosure.

20. The method of claim 16, wherein the channel comprises pipe sections that connect with and extend transversely from a housing of the sensor, and the pipe sections connect with the gas outlet.

21. The method of claim 20, wherein the gas sensor further comprises a second channel comprising pipe sections that connect with and extend transversely from the sensor housing and further connect with the gas inlet to facilitate flow of gas within the gas inlet into a cavity within the sensor housing that is in fluid communication with the cathode side of the assembly.

22. The method of claim 15, wherein the gas sensor further comprises a second channel that facilitates fluid communication between the cathode side of the assembly and the ambient environment surrounding the enclosure.

23. The method of claim 15, wherein the concentration of hydrogen within the enclosure is determined based upon the measured open circuit voltage.

24. The method of claim 15, wherein the polymer electrolyte membrane comprises a sulfonated perfluoropolymer.
